(19) United States
(12) Patent Application Publication
(10) Pub. No.: US 2026/0286539 A1
(43) Pub. Date: Sep. 24, 2026

(54) ELECTROCHEMICAL REDUCTION OF CO2 EMISSIONS TO A GREEN REDUCTION PRODUCT AND ITS SALTS

(71) Applicant: SAUDI ARABIAN OIL COMPANY, Dhahran (SA)

(72) Inventors: Murtadha J. ALTAMMAR, Dhahran (SA); Rima Taqi ALFARAJ, Dhahran (SA)

(73) Assignee: SAUDI ARABIAN OIL COMPANY, Dhahran (SA)

(21) Appl. No.: 19/087,353

(22) Filed: Mar. 21, 2025

(51) Int. Cl. C25B 3/26; C09K 8/68; C09K 8/80; C25B 3/07; C25B 11/032; C25B 11/081; C25B 15/08

(52) U.S. Cl. CPC C25B 3/26; C09K 8/68; C09K 8/80; C25B 3/07; C25B 11/032; C25B 11/081; C25B 15/081; C25B 15/087

(57) ABSTRACT

Gas emissions and waste byproducts from industrial sources may be collected and repurposed into economical value products in a sustainable, scalable manner. Means of converting these emissions and waste products may include electrochemical, or electrocatalytic, reduction reaction. Methods may comprise: capturing a CO₂ gas emission; introducing the CO₂ gas emission and an aqueous solution to an electrolysis cell having a catalyst therein; applying an electrical potential to the electrolysis cell sufficient to reduce the CO₂ gas emission into the reduction product; collecting a remnant of the aqueous solution from the electrolysis cell for reintroduction back into the electrolysis cell; and purifying the reduction product from the electrolysis cell.

### FIELD OF THE DISCLOSURE

The present disclosure relates to systems and methods for the capture and utilization of gas emissions and, more particularly, the electroreduction of CO₂ gas emissions into a reduction product.

### BACKGROUND

Hydrocarbon extraction and refinement has contributed to rising CO₂ levels, adversely impacting the environment locally by ecosystem disruption and globally by climate change. The escalation of CO₂ in the atmosphere has led to rises in global temperatures and sea levels, ocean acidification, and the melting of glaciers. Current methods of CO₂ reduction include carbon capture and subterranean storage, where the captured CO₂ is compressed and transported to an appropriate storage site. The stored CO₂ may be repurposed in a circular carbon economy, where the captured carbon emissions and its manufacturing resources are recycled and converted into economically valuable products such as methanol, ethylene, formic acid, methane for use as fuel, oil and gas well stimulates, or industrial chemicals.

Current methods of CO₂ capture from emissions of industrial sources such as mineral production plants, iron and steel manufacturing plants, hydrogen production plants, and ethanol plants include methods of collection such as direct carbon capture and point-source carbon capture (e.g. solvent-based scrubbing, semi-permeable membrane, or solid sorbents). These captured emissions may not only be stored in subterranean formations such as carbonate reservoirs or aquifers, but may also be repurposed into value products through methods such as thermochemical transformation, photochemical transformation, or electrochemical reduction. However, there is a need for upscaling and optimization of a sustainable system for the efficient conversion of captured carbon to effectively mitigate industrial emissions on a commercial, cost-effective scale.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more aspect, the present disclosure provides a method of electrocatalytic reduction of a gas emission into a reduction product, comprising: capturing a CO₂ gas emission; introducing the CO₂ gas emission and an aqueous solution to an electrolysis cell having a catalyst therein; applying an electrical potential to the electrolysis cell sufficient to reduce the CO₂ gas emission into the reduction product; collecting a remnant of the aqueous solution from the electrolysis cell for reintroduction back into the electrolysis cell; and purifying the reduction product from the electrolysis cell.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a non-limiting method of generating formic acid reduction product from wastewater and a CO₂ gas emission electroreduction product.

FIG. 2 is a block diagram of a non-limiting method of generating a formate salt reduction product from wastewater and a CO₂ gas emission electroreduction product.

FIG. 3 is a diagram of a non-limiting system and method of the present disclosure converting/reducing captured CO₂ gas emissions and wastewater for the production of green formate and a slickwater fracturing fluid.

### DETAILED DESCRIPTION

The present disclosure relates to systems and methods for the conversion of CO₂ gas emissions and an aqueous solution via electroreduction into reduction product and/or its salt.

As discussed above, there is a desire for not only the management of atmospheric CO₂ levels and other pollutants, but the conversion or reduction of the emissions into value products as well. Current methods, such as thermochemical reactions including hydrogenation, carboxylation, reformation, and mineralization of CO₂ are promising, but limited in scalability and the relatively high cost of reactants, as well as the complexity of the reaction.

As a solution to the foregoing issues, the present disclosure provides systems and methods for electrochemical reduction of CO₂ to a reduction product such as formate by use of recycled waste products and gas emissions. The electrochemical, or electrocatalytic, reduction may combine electrochemistry (interconverting electrical and chemical energy) and catalysis (enhanced rate of chemical reaction) to reduce CO₂ gas emission into a value product. The electrocatalytic process may comprise of cathodic and anodic processes occurring in at least two separate compartments. Waste products such as wastewater may be a reusable source of an aqueous solution for facilitating the electrochemical reduction. The electrocatalytic reduction of CO₂ may be coupled with a renewable aqueous solution at scale.

Accordingly, methods of electrocatalytic reduction of a gas emission into a reduction product in the present disclosure may comprise: capturing a CO₂ gas emission; introducing the CO₂ gas emission and an aqueous solution to an electrolysis cell having a catalyst therein; applying an electrical potential to the electrolysis cell sufficient to reduce the CO₂ gas emission into the reduction product; collecting a remnant of the aqueous solution from the electrolysis cell for reintroduction back into the electrolysis cell; and purifying the reduction product from the electrolysis cell.

An aqueous solution may be reacted with a captured CO₂ gas emission to produce an economically valuable reduction product. The aqueous solution may be a solution comprised of water, brine, produced water, flowback water, brackish water, sea water, wastewater, or any combination thereof. In one or more embodiments, the water is collected from a plurality of industrial processes, including discharge from mineral mining and processing, metal finishing operations, oil and gas plants and fracking, fossil fuel power stations, chemical manufacturing, animal feeding operations, industrial laundries, iron and steel production, food processing, and the like.

In some embodiments, the aqueous solution may comprise foreign materials and/or impurities including, but not limited to, residual electrolytes, unreacted CO₂, hydrocarbons, salts, heavy metals, or any combination thereof. The aqueous solution may pass through at least one treatment phase comprised of any methods known to those of ordinary skill in the art. In a non-limiting example, the treatment phase of the aqueous solution may comprise desalinization, sono arsenic filtration, membrane filtration, ultraviolet irradiation, electrochemical oxidation, or any combination thereof. In another non-limiting example, the aqueous solution may pass through a treatment phase including screening, primary settling, biological treatment, secondary clarification, tertiary treatment, disinfection, or any combination thereof. After the treatment phase, the aqueous solution may be introduced into an anode compartment of an electrolysis cell within a chamber.

The CO₂ gas emission may be sourced from the ambient atmosphere, storage spaces, or any of a plurality of processes with no particular preference. In one or more embodiments, the CO₂ gas emission is captured from a combustion process, an oil and gas wellhead, fossil fuel combustion, a large-scape gas operation, flaring emissions, flue gas emissions, from the atmosphere, or any combination thereof. The CO₂ gas emission may be captured by any method familiar to one of ordinary skill in the art. In a non-limiting example, the CO₂ gas emission is captured by a gas capture technique comprising gas compression and transportation, direct air capture, aqueous amine-based CO₂ capture, membrane gas separation, chemical looping, cryogenic carbon capture, point-source carbon capture techniques such as solvent-based scrubbing, semi-permeable membrane, or solid sorbents, or any combination thereof.

In one or more embodiments, the CO₂ gas may be captured by a gas capture apparatus that bears some similarities to conventional gas chromatographs. In non-limiting examples, the gas capture apparatus may include a heated injection port and a column housed within a temperature-controlled space, such as a temperature-controlled oven. A gas supply containing CO₂ gas may be injected into a port to vaporize the gas, and the vaporized gas(es) may then flow into a separation medium, typically with a carrier gas such as helium, before being introduced into the one or more compressors.

Compression of the captured CO₂ gas in preparation for delivery into the electrolysis cell may use one or more compressors that are configured to introduce a compressed gas into an electrolysis cell. Particular configurations and types of the one or more compressors are not believed to be especially limited. In some examples, the one or more compressors may utilize liquid injection when pressurizing the one or more gases. In non-limiting examples, the one or more compressors may be cooled by the liquid injection. The liquid injection may be advantageous for high-pressure environments while still maintaining operations at low temperatures.

The compressed captured CO₂ gas emission may be transported to and introduced into the electrolysis cell by no particular method. In some embodiments, the CO₂ gas emission may be introduced into a cathode compartment of the electrolysis cell by an aqueous feed, a gaseous feed, a humidified feed, or any combination thereof.

The electrocatalytic reduction between the treated aqueous solution and the captured and compressed CO₂ gas emission may take place in an electrolysis cell. The electrolysis cell may be housed in a chamber (i.e., reactor). The electrolysis cell may be a device such as an electrochemical cell capable of facilitating a non-spontaneous redox reaction. In several embodiments, the electrolysis cell comprises a cathode compartment and an anode compartment separated by an electrolyte solution and optionally a barrier including, but not limited to, a porous glass frit, a microporous separator, an ion exchange membrane, or any other ion conducting bridge. The electrolysis cell may be presented in any compartment configuration known to those of ordinary skill in the art. In a non-limiting example, the electrolysis cell is configured in a two-compartment configuration, a three-compartment configuration, or an undivided configuration.

The electrolysis cell within the chamber may be filled with an electrolyte solution possessing a pH no greater than 10. In some embodiments, the electrolyte solution is an aqueous solution that may comprise an acidic solution or a suitable ionic solution. The electrolyte solution may comprise water containing dissolved ions (e.g. potassium hydroxide) and/or molten sodium chloride. The pH of the electrolyte solution may determine the reduction product of the electrochemical reduction of CO₂. In a non-liming example, the formation of a formate (HCOO—) salt reduction product occurs where the electrolyte solution in the electrolysis cell ranges from neutral to slightly alkaline and may have a pH ranging from about 7 to about 10. In another non-limiting example, the formation of a formic acid (HCOOH) reduction product occurs where the electrolyte solution in the electrolysis cell possesses an acidic pH less than 4. In yet another non-limiting example, the electrolyte solution in the electrolysis cell possesses approximately a pH ranging from 4 to 7 wherein there is no catalyst present in the electrolysis cell.

The anode compartment within the electrolysis cell may comprise an electrode submerged in an electrolyte solution. The anode may be present in a plurality of configurations and compositions that are not particularly limited. In a non-limiting example, the anode is configured in a mesh formation or a porous formation. In various embodiments, the anode is a counter electrode comprising platinum, titanium, aluminum, nickel-iron foam, glassy carbon, or any combination thereof. In other embodiments, the anode is a dimensional stable anode (DSA) or a particulate anode.

The cathode compartment within the electrolysis cell may comprise an electrode submerged in an electrolyte solution. The cathode may be present in a plurality of configurations and compositions that are not particularly limited. In a nonlimiting example, the cathode comprises a gas diffusion electrode, a catalyst-coated membrane electrode, a fixed-bed cathode, or any combination thereof.

In some embodiments, the cathode comprises one or more electrocatalysts on a surface of the cathode. Though not to be bound by theory, a surface catalyst on an electrode may enhance the rate of reaction for oxidation or reduction. In a non-limiting example, the cathode is coated in a metal catalyst selected from the group consisting of tin (Sn), bismuth (Bi), palladium (Pd), indium (In), and any combination thereof. In another non-limiting example, wherein the reduction product comprises a salt, the cathode is coated in a metal catalyst selected from the group consisting of cobalt (Co), copper (Cu), antimony (Sb), and any combination thereof.

In order to initiate the electrocatalytic reduction of CO₂ into a reduction product, an electrical potential may be applied between the anode compartment and cathode compartment of the electrolysis cell. The electrical potential applied may be sufficient to reduce CO₂ to a reduction product. The electrical potential may be generated from a variable voltage source. In a non-limiting example, the electrical potential is a DC voltage (as units of voltage vs saturated calomel electrode (SCE) applied at a general range of about −1.42V vs SCE to about −1.60V vs SCE.

As the electric potential is applied to the electrolysis cell, the anode and cathode compartments may undergo a redox reaction. In a non-limiting example, the treated aqueous solution in the anode compartment may undergo oxidation once the electrical potential is applied, wherein the aqueous solution is oxidized to produce an O2 gas and protons (Reaction 1).

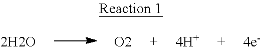

In some embodiments, the applied electrical potential on the CO₂ within the cathode compartment may yield a reduction product via a reduction reaction. The resulting reduction product may be determined by the physiological conditions within the electrolysis cell. In a non-limiting example, the CO₂ within the cathode compartment is reduced into formic acid (HCOOH) in an acidic electrolyte solution that is at a pH of 4 or less (Reaction 2).

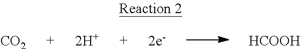

In an alternative embodiment, a salt reduction product may be formed where the electrolysis cell comprises an electrolyte solution that is neutral to slightly alkaline. In a non-limiting example, the CO₂ within the cathode compartment is reduced into formate in an electrolyte solution at a pH ranging from about of 7 to about 10 (Reaction 3).

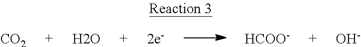

The resulting reduction product or the salt of the reduction product within the electrolysis cell may be present at a plurality of concentrations within the electrolyte solution. In a non-limiting example, the reduction product or the salt of the reduction product is present at a concentration of about 50 ppm to about 10,000 ppm, including all subranges and concentration values (e.g. 50 ppm, 100 ppm, 200 ppm, 500 ppm, 1,000 ppm, 2,500 ppm, 5,000 ppm, 7,500 ppm, or 10,000 ppm). In various embodiments, the reduction product includes concentration ranges of 50 ppm to 7,500 ppm, 100 ppm to 7,500 ppm, 200 ppm to 7,500 ppm, 500 to 7,500 ppm, 1,000 ppm to 7,500 ppm, 2,500 ppm to 7,500 ppm, 5,000 to 7,500 ppm, 50 ppm to 100 ppm, 200 ppm to 500 ppm, 100 ppm to 1,000 ppm, or 2,500 ppm to 5,000 ppm.

After an electrical potential is applied to the electrolysis cell and the anode and cathode compartments undergo a redox reaction, remnant or residual aqueous solution in the anode compartment may be recycled for reuse in a subsequent electrocatalytic reduction. The remnant or residual aqueous solution may be recycled by being removed from the anode compartment and returned to the treatment phase by no particular means or method.

The resulting redox reaction after the application of the electrical potential on the electrolysis cell yields a reduction product in proximity to the cathode. The reduction product may be separated from the electrolyte solution by a plurality of distillation or extraction methods known to one of ordinary skill in the art. In some embodiments, the reduction product may be purified and separated from the electrolyte solution of the cathode compartment by any methods known to one of ordinary skill in the art. In a non-limiting example, the reduction product may be separated by a separation technique comprising extractive distillation, vacuum distillation, reactive distillation, salting-out extraction, supercritical fluid extraction, liquid-liquid extraction, crystallization, precipitation, adsorption, electrodialysis, or any combination thereof.

The purified reduction product may be dissolved or suspended in an aqueous fluid, such as fresh water, saltwater, brine, seawater, wastewater, purified wastewater, the like, or any combination thereof. When the reduction product is formic acid or a formate salt, the aqueous fluid comprising dissolved or suspended formic acid or formate salt may be referred to herein as an “aqueous formate fluid.”

Additionally, in various aspects, the present disclosure provides a slickwater fluid comprising an aqueous formate fluid and methods of use thereof for any number of subterranean operations. The slickwater fluid may be any non-viscosified aqueous fluid, viscosified aqueous fluid, or hybrid thereof, designed or suitable for use in a subterranean operation to achieve a desired purpose. A slickwater fluid may be configured to perform a fracturing operation with a subterranean formation of a specified type (e.g., a slickwater fluid may further comprise proppant particulates, a friction reducer, and optional chemicals or additives.

Subterranean operations may take place in subterranean formations that include, but are not limited to, saline aquifers (e.g., sandstones and the like), oil reservoirs (e.g., for enhanced oil recovery and carbon storage), unconventional formations (e.g., shale formations, tight sandstones, tight carbonates, tight coals, the like, and any combination thereof), or the like. Non-limiting examples of subterranean operations for which a slickwater fluid may be designed and used include enhanced oil recovery operations (e.g., water, chemical, or gas (e.g., CO₂) flooding operations), fracturing operations, acidizing operations, gravel-packing operations, or the like, or any combination thereof. Preferably, the slickwater fluids of the present disclosure may be used in conjunction with a fracturing operation, since doing so may both improve production of a natural resource from the subterranean formation and facilitate underground carbon storage.

The slickwater fluids may include various components suitable for a particular subterranean formation operation or other downstream operation.

The formate fluids described in the slickwater fluids may comprise a salt of the reduction product from the electrochemical reduction of CO₂, herein referred to as a formate. Formate refers to the formate anion (HCOO—), which dissociates in aqueous solution of formic acid and/or salts thereof, or upon hydrolysis of formate esters. Formate salts such as sodium, potassium, cesium, or the like, or blends of said formate salts, such as sodium/potassium formate blends, are highly soluble in water, with maximum solubilities of about 30 weight percent (wt. %) to about 80 wt. % of formate anion, based on total fluid mass. Aqueous formate solutions also have relatively high densities, with maximum densities up to 1.3 g/cm³ (10.8 pounds per gallon (ppg)) for sodium formate, up to 1.57 g/cm³ (13.1 ppg) for potassium formate, and up to 2.3 g/cm³ (19.2 ppg) for cesium formate.

In various embodiments, slickwater fluids may comprise an aqueous formate solution having at least about 5 weight percent (wt. %) of formate anions, based on the total weight of the slickwater fluid (e.g., at least about 5 wt. %, 10 wt. %, 15 wt. %, 20 wt. %, 25 wt. %, 30 wt. %, 35 wt. %, 40 wt. %, 45 wt. %, 50 wt. %, or greater). In various embodiments, slickwater fluids comprising an aqueous formate solution may comprise about 5 wt. % to about 50 wt. %, including any wt. % value or range therebetween, of formate anions, based on the total weight of the slickwater fluid (e.g., about 5 wt. % to about 30 wt. %, about 30 wt. % to about 50 wt. %, about 10 wt. % to about 40 wt. %, about 15 wt. % to about 35 wt. %, or about 20 wt. % to about 30 wt. %). In various embodiments, slickwater fluids comprising an aqueous formate solution may comprise about 30 wt. % to about 50 wt. % of formate anions, based on the total weight of the slickwater fluid. In various embodiments, slickwater fluids may comprise a saturated aqueous formate solution.

Slickwater fluids may comprise various formate compounds capable of generating formate anions, such as by dissociation or reaction, e.g., hydrolysis of a formate ester. Formate compounds may comprise formic acid, a formate salt, a formate salt hydrate, a formate ester, or any combination thereof. A formate salt may comprise a single formate salt or a mixture of two or more formate salts. Suitable formate salts include, but are not limited to, alkali metal formate salts, alkali earth metal formate salts, or the like. Examples of suitable formate salts include, but are not limited to, sodium formate, potassium formate, cesium formate, lithium formate, calcium formate, magnesium formate, ammonium formate, the like, or any combination thereof. In some embodiments, suitable formate salts may comprise sodium formate, potassium formate, and/or cesium formate. In some embodiments, an aqueous formate solution may comprise a buffer (e.g., an acidic buffer) of formic acid and one or more formate salts. In an embodiment, an acidic formic acid-formate salt buffer may have a pH of about 3 to about 4, including all pH values and ranges therebetween. A formate ester may comprise a single formate ester or a mixture of two or more formate esters. Suitable formate esters may include methyl formate, the like, or any combination thereof.

A slickwater fluid may comprise an aqueous formate fluid at various solution densities. In various embodiment, an aqueous formate fluid may have a density of about 1.05 g/cm³ to about 2.3 g/cm³, including all g/cm³ values and ranges therebetween (e.g., from about 1.05 g/cm³ to about 1.5 g/cm³, from about 1.5 g/cm³ to about 2 g/cm³, from about 2 g/cm³ to about 2.5 g/cm³, or greater). In various embodiment, an aqueous formate fluid may have a density of about 1.1 g/cm³ to about 1.5 g/cm³.

Slickwater fluids of the present disclosure may further comprise one or more additives suitable for a particular subterranean operation. Slickwater fluids of the present disclosure may comprise proppant particles, a friction reducer, and optionally, one or more additives. In one embodiment, slickwater fluids of the present disclosure are present and comprise at least one additive selected from the group consisting of a biocide, a surfactant, a clay stabilizer, a gel breaker, a diverter, a scale inhibitor, a corrosion inhibitor, a crosslinking agent, an iron control agent, a pH-adjusting agent, a salt, a weighting agent, the like, and any combination thereof.

The slickwater fracturing fluids of this disclosure may include breakers that may degrade gelling polymers or other viscosified fluids within the subterranean formation. Suitable breakers include acid breakers, bacteria-based breakers, enzyme-based breakers, oxidative breakers, the like, and any combination thereof. Common polymers broken by a breaker include guar, hydroxypropyl guar, xanthan gum, the like, and any combination thereof. The breakers may be encapsulated or not encapsulated. When used, breakers may be present in the slickwater fracturing fluid in a range from about 0.003 wt. % to about 1.3 wt. %, based on the total weight of the slickwater fracturing fluid.

An aqueous formate solution of the present disclosure may perform additional roles in a slickwater fluid, such as a slickwater fracturing fluid. In various embodiments, an aqueous formate solution may interact with subterranean formation surfaces (e.g., fracture surfaces induced by a fracturing operation, or the like) to adsorb onto kerogen and/or other organic matter, potentially releasing adsorbed methane and other gases. An aqueous formate solution may also release carbon dioxide, which similarly may adsorb onto kerogen and/or other organic matter, thereby releasing adsorbed methane or the like. An aqueous formate solution may interact with subterranean formation surfaces to adsorb onto clay, preventing swelling during operations, which can cause damage to and reduce permeability of the subterranean formation. A slickwater fluid comprising a high-density aqueous formate solution may also require lower pressure and/or flow rate to achieve the same level of reservoir stimulation, thus reducing the risk of formation damage. An aqueous formate solution may comprise a formic acid-formate anion buffer and breaker system, in which the buffer maintains an acidic pH that hydrolyzes a breaker (e.g., a formate ester) and releases acid to break down gelled polymers. An acidic aqueous formate solution may also act as a fracturing agent in a subterranean formation.

As referenced above, slickwater fluids of the present disclosure (e.g., a slickwater fluid comprising an aqueous formate fluid, proppant particulates, and optionally, one or more additives) may be utilized in conjunction with hydraulic fracturing to enhance production from a subterranean formation, preferably by creating or enhancing one or more fractures within the matrix of a subterranean formation, while concurrently achieving underground carbon storage via the formate ions in the slickwater fluid. Such methods may be accomplished by introducing the slickwater fracturing fluid into the subterranean formation at or above a fracture net pressure of the subterranean formation, and thereafter retaining at least a portion of the formate anions within the subterranean formation.

Accordingly, in various aspects, the present disclosure provides methods for use of slickwater fluids (e.g., slickwater fracturing fluids) comprising aqueous formate fluid in subterranean operations for underground carbon storage and enhanced hydrocarbon production from said subterranean formations. In various embodiments, methods for underground carbon storage and enhanced hydrocarbon production from subterranean formations may comprise use of any slickwater fluids of the present disclosure. Methods of the present disclosure may comprise: introducing a slickwater fluid to a subterranean formation during a subterranean operation; contacting the slickwater fluid with a matrix of the subterranean formation; and retaining at least a portion of the formate anions within the subterranean formation.

In various embodiments, at least a portion of the formate anions are stored within the subterranean formation. Storage of the formate anions within the subterranean formation may comprise removal and retention of the formate anions from the slickwater fluid by the subterranean formation during the subterranean operation (e.g., formate anions remain within the subterranean formation, such as through adsorption to the formation matrix, when the slickwater fluid returns to an injection well or a production well), or alternately, the slickwater fluid may remain within the subterranean formation to facilitate retention of the formate anions therein.

Embodiments of the present disclosure will now be described in detail with reference to the accompanying Figures. Like elements in the various figures may be denoted by like reference numerals for consistency. Additionally, it will be apparent to one of ordinary skill in the art that the scale of the elements presented in the accompanying Figures may vary without departing from the scope of the present disclosure.

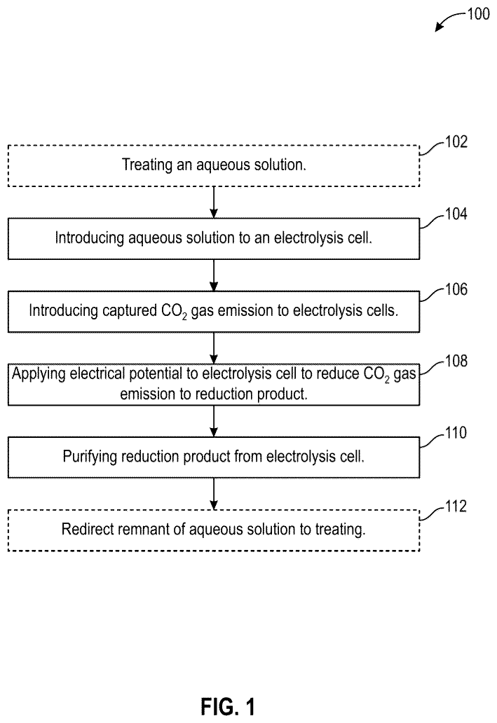

FIG. 1 is a block diagram of a non-limiting system and method 100 for generating a green formic acid reduction product from the electroreduction of CO₂ gas and an aqueous solution. At block 104, an aqueous solution is transported and placed into the first chamber of an electrolysis cell, where the first chamber contains an anode and is filled with an electrolyte solution at an acidic pH of 4 or less.

At block 106, a CO₂ gas emission is captured and compressed to prepare for transportation. The gas emissions may be captured or compressed by any method known to those of ordinary skill in the art. The CO₂ gas emission may be supplied from a plurality of sources, including but not limited to, a hydrocarbon production plant. The compressed gas emissions are transported and placed into a second chamber of the electrolysis cell, the second chamber containing a cathode and filled with an electrolyte solution at an acidic pH of 4 or less.

After the introduction of the purified aqueous solution and the CO₂ gas emission, at 108 the electrolysis cell is subjected to electrolysis as an electrical potential is applied between the anode and cathode of the electrolysis cell. The aqueous solution is reduced to O₂ in the anode compartment, and the CO₂ is reduced to a formic acid (HCOOH) reduction product and H₂. At block 110, the formic acid reduction product is purified and separated from the electrolyte solution of the cathode compartment of the electrolysis cell. The purification of the formic acid reduction product is not limited by any particular method, and may include distillation, extraction, crystallization, precipitation, absorption, electrodialysis, and any combination thereof.

Optionally, at block 102, an aqueous solution may be collected and purified at a treatment phase prior to transport at block 104. The treatment phase may comprise one or more methods including, but not limited to, desalinization, sono arsenic filtration, membrane filtration, ultraviolet irradiation, electrochemical oxidation, and the like. The source of the aqueous solution is not particularly limited and may comprise wastewater in one or more examples.

At block 112, optionally any residual treated aqueous solution remnant in the electrolysis cell after electrolysis is redirected back to the aqueous solution treatment phase at 102 for reuse in the electrolysis at 108.

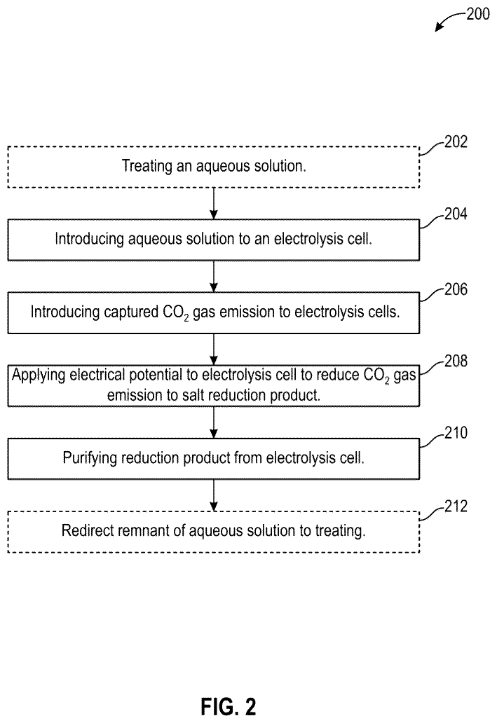

FIG. 2 is a block diagram of a non-limiting system and method 200 for generating a green formate salt reduction product from the electroreduction of CO₂ gas and an aqueous solution. At block 204, the purified aqueous solution is transported and placed into the first chamber of an electrolysis cell, where the first chamber contains an anode and is filled with an electrolyte solution at pH ranging from about 7 to about 10.

At block 206, a CO₂ gas emission is captured and compressed to prepare for transportation. The gas emissions may be captured or compressed by any method known to those of ordinary skill in the art. The CO₂ gas emission may be supplied from a plurality of sources, including but not limited to, a hydrocarbon production plant. The compressed gas emissions are transported and placed into a second chamber of the electrolysis cell, the second chamber containing a cathode and filled with an electrolyte solution at pH ranging from about 7 to about 10.

After the introduction of the purified aqueous solution and the CO₂ gas emission, at 208 the electrolysis cell is subjected to electrolysis as an electrical potential is applied between the anode and cathode of the electrolysis cell. The aqueous solution is reduced to O₂ in the anode compartment, and the CO₂ is reduced to a formate salt (HCOO—) reduction product and H₂. At block 210, the formate salt reduction product is purified and separated from the electrolyte solution of the cathode compartment of the electrolysis cell. The purification of the formate salt reduction product is not limited by any single particular method.

Optionally, at block 202, an aqueous solution is collected and purified at a treatment phase by methods including, but not limited to, desalinization, sono arsenic filtration, membrane filtration, ultraviolet irradiation, electrochemical oxidation, and the like. The source of the aqueous solution is not particularly limited and may comprise wastewater in one or more examples.

At block 212, optionally any residual treated aqueous solution remnant in the electrolysis cell after electrolysis is redirected back to the aqueous solution treatment phase at 102 for reuse in the electrolysis at 208.

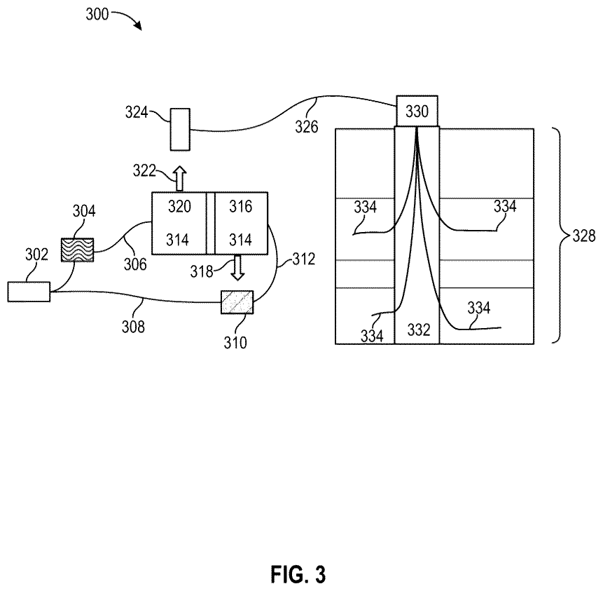

FIG. 3 is a diagram of a non-limiting system and method of the present disclosure reducing a captured CO₂ gas emission and aqueous solution to a green formate and its salt at scale. As shown, system and method of 300 includes the capture and compression of a gas emission from a gas emitting source 302 that may include, but is not limited to, mineral production plants, iron and steel manufacturing plants, hydrogen production plants, ethanol plants, and the like, or a subterranean storage formations of gases. Said gas emissions may be compressed at compressor 304 and transported 306 for introduction into the cathode compartment of an electrolysis cell 320. The aqueous solution may originate from gas emitting source 302 as a wastewater byproduct, and may be transported 308 towards a treatment phase 310 for purification. Purification methods at treatment phase 310 may include, but are not limited to, desalinization, sono arsenic filtration, membrane filtration, ultraviolet irradiation, electrochemical oxidation, or any combination thereof. Similarly, the purified aqueous solution at 310 is transported 312 into the anode compartment 316 of said electrolysis cell. The electrolysis cell is filled with an electrolyte solution 314 in both compartments, and may vary in pH depending on a target formate product. Optionally, the electrolyte solution may be at a pH of 4 or less for the production of formic acid (HCOOH). Alternatively, the pH of the electrolyte solution 314 may range from about 7 to about 10 for the production of a formate salt (HCOO—).

To produce formic acid, formate, and/or its salt, an electric potential may be applied to the electrolysis cell compartments 316 and 320 to reduce the gas emission to a reduction product (e.g. a formate salt or formic acid). After the electrochemical reduction reaction, any remaining aqueous solution in the anode compartment 316 may be recycled 318 back towards the treatment phase 310 for reuse. The reduction product may be utilized upstream as it is transferred 322 towards a formulation unit 324 to produce a slickwater fluid. The reduction product may be converted into an aqueous formate fluid comprising formate anions for incorporation into the slickwater fluid, and the slickwater fluid may also comprise a plurality of additives including, but not limited to, proppant particulates and a friction reducer. Slickwater fluid formation methods and techniques at formulation unit 324 may include any methods or apparatus known to those of ordinary skill in the art. The slickwater fluid is injected 326 through wellhead 330 into an oil and gas well 332 within a subterranean formation 328 during a slickwater fracturing operation. The slickwater fluid may be retained in the subterranean formation 328 after injection, leaving a portion of formate anions 334 behind in the subterranean formation 328 for storage. The present disclosure is not limited in the number of locations the slickwater fluid may infiltrate in the subterranean formation 328 and store formate anions 334.

### EXAMPLE EMBODIMENTS

Embodiments disclosed herein include:

A. A method of electrocatalytic reduction of a gas emission into a reduction product, comprising: capturing a CO₂ gas emission; introducing the CO₂ gas emission and an aqueous solution to an electrolysis cell having a catalyst therein; applying an electrical potential to the electrolysis cell sufficient to reduce the CO₂ gas emission into the reduction product; collecting a remnant of the aqueous solution from the electrolysis cell for reintroduction back into the electrolysis cell; and purifying the reduction product from the electrolysis cell.

Embodiment A may have one or more of the following elements in any combination:

Element 1: wherein the aqueous solution comprises water, brine, produced water, flowback water, brackish water, sea water, wastewater, or any combination thereof.

Element 2: wherein the method further comprises treating the aqueous solution by a process comprising desalinization, sono arsenic filtration, membrane filtration, ultraviolet irradiation, electrochemical oxidation, or any combination thereof prior to introducing the aqueous solution to the electrolysis cell.

Element 3: wherein the method further comprises collecting a remnant of the treated aqueous solution from the electrolysis cell for reintroduction back into the treating.

Element 4: wherein the method further comprises collecting a salt of the reduction product from the electrolysis cell comprising an electrolyte solution with a pH ranging from about a pH of 7 to about a pH of 10.

Element 5: wherein the wastewater comprises residual electrolytes, unreacted CO₂, hydrocarbons, salts, heavy metals, or any combination thereof.

Element 6: wherein the CO₂ gas emission is captured from a combustion process, an oil and gas wellhead, fossil fuel combustion, a large-scape gas operation, flaring emissions, flue gas emissions, the atmosphere, or any combination thereof.

Element 7: wherein the CO₂ gas emission is captured by a gas capture technique comprising gas compression and transportation, direct air capture, aqueous amine-based CO₂ capture, membrane gas separation, chemical looping, cryogenic carbon capture, or any combination thereof.

Element 8: wherein the electrolysis cell comprises an electrolyte solution with a pH up to a pH of 10.

Element 9: wherein the electrolysis cell comprises a cathode compartment and an anode compartment separated by an electrolyte solution.

Element 10: wherein the cathode compartment comprises a gas diffusion electrode, a catalyst-coated membrane electrode, a fixed-bed cathode, or any combination thereof.

Element 11: wherein the captured CO₂ gas emission is placed into the cathode compartment by an aqueous feed, a gaseous feed, a humidified feed, or any combination thereof.

Element 12: wherein the catalyst selected from the group consisting of tin (Sn), bismuth (Bi), palladium (Pd), indium (In), and any combination thereof.

Element 13: wherein the at least one catalyst comprises In and the electrolysis cell comprises an electrolyte solution at a pH below 5.5.

Element 14: wherein the catalyst is at least one metal selected from the group consisting of cobalt (Co), copper (Cu), antimony (Sb), and any combination thereof.

Element 15: wherein the electrolysis cell comprises a two-compartment configuration, a three-compartment configuration, or an undivided configuration.

Element 16: wherein the purifying the reduction product from the electrolysis cell comprises a separation technique comprising extractive distillation, vacuum distillation, reactive distillation, salting-out extraction, supercritical fluid extraction, liquid-liquid extraction, crystallization, precipitation, adsorption, electrodialysis, or any combination thereof.

Element 17: wherein the reduction product comprises formic acid (HCOOH) or a salt thereof, and wherein the purified formic acid or a purified salt thereof is present at a concentration of about 50 ppm to about 10,000 ppm.

Element 18: wherein the method further comprises formulating a slickwater fracturing fluid comprising the purified reduction product, wherein the slickwater fracturing fluid comprises: an aqueous formate fluid comprising about 5 weight percent (wt. %) to about 50 wt. % of formate anions, based on a total weight of the slickwater fracturing fluid; proppant particulates; a friction reducer; and optionally, one or more additives; and placing the slickwater fracturing fluid into a subterranean formation.

Element 19: wherein the method further comprises retaining at least a portion of the formate anions within the subterranean formation.

By way of non-limiting example, exemplary combinations applicable to A include, but are not limited to Elements 1-19 in any combination.

### Additional Embodiments

The present disclosure is further directed to the following exemplary embodiments which can be practiced in any combination thereof:

Embodiment 1. A method of electrocatalytic reduction of a gas emission into a reduction product, comprising: capturing a CO₂ gas emission; introducing the CO₂ gas emission and an aqueous solution to an electrolysis cell having a catalyst therein; applying an electrical potential to the electrolysis cell sufficient to reduce the CO₂ gas emission into the reduction product; collecting a remnant of the aqueous solution from the electrolysis cell for reintroduction back into the electrolysis cell; and purifying the reduction product from the electrolysis cell.

Embodiment 2. The method of Embodiment 1, wherein the aqueous solution comprises water, brine, produced water, flowback water, brackish water, sea water, wastewater, or any combination thereof.

Embodiment 3. The method of any one of Embodiment 1 or Embodiment 2, further comprising treating the aqueous solution by a process comprising desalinization, sono arsenic filtration, membrane filtration, ultraviolet irradiation, electrochemical oxidation, or any combination thereof prior to introducing the aqueous solution to the electrolysis cell.

Embodiment 4. The method of Embodiment 3, further comprising collecting a remnant of the treated aqueous solution from the electrolysis cell for reintroduction back into the treating.

Embodiment 5. The method of any one of Embodiments 1-4, further comprising: collecting a salt of the reduction product from the electrolysis cell comprising an electrolyte solution with a pH ranging from about a pH of 7 to about a pH of 10.

Embodiment 6. The method of Embodiment 2, wherein the wastewater comprises residual electrolytes, unreacted CO₂, hydrocarbons, salts, heavy metals, or any combination thereof.

Embodiment 7. The method of any one of Embodiments 1-6, wherein the CO₂ gas emission is captured from a combustion process, an oil and gas wellhead, fossil fuel combustion, a large-scape gas operation, flaring emissions, flue gas emissions, the atmosphere, or any combination thereof.

Embodiment 8. The method of any one of Embodiments 1-7, wherein the CO₂ gas emission is captured by a gas capture technique comprising gas compression and transportation, direct air capture, aqueous amine-based CO₂ capture, membrane gas separation, chemical looping, cryogenic carbon capture, or any combination thereof.

Embodiment 9. The method of any one of Embodiments 1-8, wherein the electrolysis cell comprises an electrolyte solution with a pH up to a pH of 10.

Embodiment 10. The method of any one of Embodiments 1-9, wherein the electrolysis cell comprises a cathode compartment and an anode compartment separated by an electrolyte solution.

Embodiment 11. The method of Embodiment 10, wherein the cathode compartment comprises a gas diffusion electrode, a catalyst-coated membrane electrode, a fixed-bed cathode, or any combination thereof.

Embodiment 12. The method of any one of Embodiments 1-11, wherein the captured CO₂ gas emission is placed into the cathode compartment by an aqueous feed, a gaseous feed, a humidified feed, or any combination thereof.

Embodiment 13. The method of any one of Embodiments 1-12, wherein the catalyst selected from the group consisting of tin (Sn), bismuth (Bi), palladium (Pd), indium (In), and any combination thereof.

Embodiment 14. The method of any one of Embodiments 1-13, wherein the at least one catalyst comprises In and the electrolysis cell comprises an electrolyte solution at a pH below 5.5.

Embodiment 15. The method of any one of Embodiments 1-14, wherein the catalyst is at least one metal selected from the group consisting of cobalt (Co), copper (Cu), antimony (Sb), and any combination thereof.

Embodiment 16. The method of any one of Embodiments 1-15, wherein the electrolysis cell comprises a two-compartment configuration, a three-compartment configuration, or an undivided configuration.

Embodiment 17. The method of any one of Embodiment 1-16, wherein the purifying the reduction product from the electrolysis cell comprises a separation technique comprising extractive distillation, vacuum distillation, reactive distillation, salting-out extraction, supercritical fluid extraction, liquid-liquid extraction, crystallization, precipitation, adsorption, electrodialysis, or any combination thereof.

Embodiment 18. The method of Embodiment 1-17, wherein the reduction product comprises formic acid (HCOOH) or a salt thereof, and wherein the purified formic acid or a purified salt thereof is present at a concentration of about 50 ppm to about 10,000 ppm.

Embodiment 19. The method of Embodiment 18, further comprising: formulating a slickwater fracturing fluid comprising the purified reduction product, wherein the slickwater fracturing fluid comprises: an aqueous formate fluid comprising about 5 weight percent (wt. %) to about 50 wt. % of formate anions, based on a total weight of the slickwater fracturing fluid; proppant particulates; a friction reducer; and optionally, one or more additives; and placing the slickwater fracturing fluid into a subterranean formation.

Embodiment 20: The method of Embodiment 19, further comprising: retaining at least a portion of the formate anions within the subterranean formation.

In the detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

1. A method of electrocatalytic reduction of a gas emission into a reduction product, comprising:
capturing a CO₂ gas emission;
introducing the CO₂ gas emission and an aqueous solution to an electrolysis cell having a catalyst therein;
applying an electrical potential to the electrolysis cell sufficient to reduce the CO₂ gas emission into the reduction product;
collecting a remnant of the aqueous solution from the electrolysis cell for reintroduction back into the electrolysis cell; and
purifying the reduction product from the electrolysis cell.

2. The method of claim 1, wherein the aqueous solution comprises water, brine, produced water, flowback water, brackish water, sea water, wastewater, or any combination thereof.

3. The method of claim 2, further comprising treating the aqueous solution by a process comprising desalinization, sono arsenic filtration, membrane filtration, ultraviolet irradiation, electrochemical oxidation, or any combination thereof prior to introducing the aqueous solution to the electrolysis cell.

4. The method of claim 3, further comprising collecting a remnant of the treated aqueous solution from the electrolysis cell for reintroduction back into the treating.

5. The method of claim 1, further comprising:
collecting a salt of the reduction product from the electrolysis cell comprising an electrolyte solution with a pH ranging from about a pH of 7 to about a pH of 10.

6. The method of claim 2, wherein the wastewater comprises residual electrolytes, unreacted CO₂, hydrocarbons, salts, heavy metals, or any combination thereof.

7. The method of claim 1, wherein the CO₂ gas emission is captured from a combustion process, an oil and gas wellhead, fossil fuel combustion, a large-scape gas operation, flaring emissions, flue gas emissions, the atmosphere, or any combination thereof.

8. The method of claim 1, wherein the CO₂ gas emission is captured by a gas capture technique comprising gas compression and transportation, direct air capture, aqueous amine-based CO₂ capture, membrane gas separation, chemical looping, cryogenic carbon capture, or any combination thereof.

9. The method of claim 1, wherein the electrolysis cell comprises an electrolyte solution with a pH up to a pH of 10.

10. The method of claim 1, wherein the electrolysis cell comprises a cathode compartment and an anode compartment separated by an electrolyte solution.

11. The method of claim 10, wherein the cathode compartment comprises a gas diffusion electrode, a catalyst-coated membrane electrode, a fixed-bed cathode, or any combination thereof.

12. The method of claim 10, wherein the captured CO₂ gas emission is placed into the cathode compartment by an aqueous feed, a gaseous feed, a humidified feed, or any combination thereof.

13. The method of claim 1, wherein the catalyst selected from the group consisting of tin (Sn), bismuth (Bi), palladium (Pd), indium (In), and any combination thereof.

14. The method of claim 13, wherein the at least one catalyst comprises In and the electrolysis cell comprises an electrolyte solution at a pH below 5.5.

15. The method of claim 5, wherein the catalyst is at least one metal selected from the group consisting of cobalt (Co), copper (Cu), antimony (Sb), and any combination thereof.

16. The method of claim 1, wherein the electrolysis cell comprises a two-compartment configuration, a three-compartment configuration, or an undivided configuration.

17. The method of claim 1, wherein the purifying the reduction product from the electrolysis cell comprises a separation technique comprising extractive distillation, vacuum distillation, reactive distillation, salting-out extraction, supercritical fluid extraction, liquid-liquid extraction, crystallization, precipitation, adsorption, electrodialysis, or any combination thereof.

18. The method of claim 1, wherein the reduction product comprises formic acid (HCOOH) or a salt thereof, and wherein the purified formic acid or a purified salt thereof is present at a concentration of about 50 ppm to about 10,000 ppm.

19. The method of claim 18, further comprising:
formulating a slickwater fracturing fluid comprising the purified reduction product, wherein the slickwater fracturing fluid comprises:
an aqueous formate fluid comprising about 5 weight percent (wt. %) to about 50 wt. % of formate anions, based on a total weight of the slickwater fracturing fluid;
proppant particulates;
a friction reducer; and
optionally, one or more additives; and
placing the slickwater fracturing fluid into a subterranean formation.

20. The method of claim 19, further comprising:
retaining at least a portion of the formate anions within the subterranean formation.
